(19) United States
(12) Patent Application Publication
(10) Pub. No.: US 2024/0236803 A1
(43) Pub. Date: Jul. 11, 2024

(54) COMMUNICATION CONNECTIVITY MANAGEMENT BASED ON UE MOBILITY CONTEXT

(71) Applicant: Apple Inc., Cupertino, CA (US)

(72) Inventors: Said Medjkouh, San Diego, CA (US); Alperen Gundogan, Munich (DE); Amr Abdelrahman Yousef Abdelrahman Mostafa, Munich (DE); Christian Hofmann, Munich (DE); Panagiotis Botsinis, Munich (DE); Sameh M. Eldessoki, Munich (DE); Seyedamirhossein Hosseini, San Diego, CA (US); Sreevalsan Vallath, Dublin, CA (US); Tarik Tabet, Carlsbad, CA (US)

(21) Appl. No.: 18/408,925

(22) Filed: Jan. 10, 2024

(30) Foreign Application Priority Data
Jan. 10, 2023 (GR) 20230100014

(51) Int. Cl. H04W 36/32; H04W 8/24; H04W 36/00

(52) U.S. Cl. CPC H04W 36/324; H04W 8/24; H04W 36/0033

(57) ABSTRACT

One or more processors are provided. The one or more processors include circuitry that executes instructions to cause a user equipment (UE) to perform operations. The operations include transmitting, to a network entity, a first message indicating a capability of the UE. The operations include determining, based on contextual information associated with the UE, an anticipated mobility event to occur during a time window. The operations include transmitting, to the network entity, a second message indicative of the mobility event. The operations include determining to make a connectivity change when the mobility event occurs. A network entity and a method are also provided.

### CROSS REFERENCE TO RELATED APPLICATIONS

This application claims priority to Greek patent application Ser. No. 20/230,100014, filed Jan. 10, 2023, the content of which is incorporated herein by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, one or more processors are provided. The one or more processors have circuitry that executes instructions to cause a UE to perform operations. The operations include transmitting, to a network entity, a first message indicating a capability of the UE. The operations include determining, based on contextual information associated with the UE, an anticipated mobility event to occur during a time window. The operations include transmitting, to the network entity, a second message indicative of the mobility event. The operations include determining to make a connectivity change when the mobility event occurs.

In some implementations, the operations further include determining that the mobility event occurs during the time window and making the connectivity change when the mobility event occurs.

In some implementations, determining to make the connectivity change when the mobility event occurs includes: receiving, from the network entity, a third message configuring the UE to make the connectivity change when the mobility event occurs.

In some implementations, the operations further include determining, based on an update of the contextual information, an anticipated change to the mobility event; and transmitting, to the network entity, a fourth message indicative of the change to the mobility event.

In some implementations, the connectivity change includes at least one of: (i) a handover of the UE from a source base station to a target base station, or (ii) changing an operating frequency band of the UE.

In some implementations, the third message further indicates a load prediction on one or more base stations associated with the network entity.

In some implementations, the contextual information includes at least one of: a user's interaction with the UE, a mobility history of the UE, information obtained from one or more sensors of the UE, or contextual information obtained from other UEs.

In some implementations, determining the anticipated mobility event based on the contextual information includes: determining, based on the contextual information, an anticipated user behavior that causes the UE to change location during the time window; and determining a correlation between the location change and the mobility event.

In some implementations, the mobility event includes at least one of: a change of a radio environment of the UE, or a change of a data traffic of the UE.

In some implementations, the operations further include receiving, from the network entity, one or more information elements that indicate a type of the mobility events supported by the UE.

In some implementations, the third message includes one or more parameters for the UE to make the connectivity change. The UE accesses the one or more parameters upon occurrence of the mobility event. The one or more parameters configure at least one of: a frequency band, an antenna, a beam, a timer that measures a radio link failure, a random access channel (RACH) preamble, a scheme for link adaptation, or a maximum number of retransmissions.

In some implementations, determining the anticipated user behavior based on the contextual information includes: inputting the contextual information to a machine learning engine; calculating, using the machine learning engine, a probability that the user behavior will occur during the time window; and comparing the probability with a predetermined confidence threshold.

In accordance with one aspect of the present disclosure, a method is provided. The method can include steps similar to one or more operations performed by the one or more processors described above.

In accordance with one aspect of the present disclosure, a network entity is provided. The network entity has one or more processors configured to execute instructions that cause the network entity to perform operations. The operations include receiving, from a UE, a first message indicating a capability of the UE. The operations include receiving, from the UE, a second message indicating an anticipated mobility event that the UE determines to occur during a time window. The operations include configuring, in anticipation of a connectivity change of the UE, one or more base stations according to the mobility event.

In some implementations, the operations further include transmitting a third message to the UE, the third message configuring the UE to make the connectivity change when the mobility event occurs.

In some implementations, the operations further include making a load prediction for the one or more base stations based on the second message. The third message further indicates the load prediction.

In some implementations, the third message includes one or more parameters for the UE to make the connectivity change. The one or more parameters configure at least one of: a frequency band, an antenna, a beam, a timer that measures a radio link failure, a random access channel (RACH) preamble, a scheme for link adaptation, or a maximum number of retransmissions.

In some implementations, the operations further include receiving a fourth message from the UE, the fourth message indicating an anticipated change to the mobility event; and reconfiguring the one or more base stations according to the anticipated change to the mobility event.

In some implementations, the connectivity change includes a handover of the UE from a source base station to a target base station of the one or more base stations.

In some implementations, the connectivity change includes changing an operating frequency band of the UE.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example scenario of communication connectivity management based on UE mobility context, according to some implementations.

FIG. 3 illustrates a flowchart of example interaction between a UE and a network entity, according to some implementations.

FIG. 4A illustrates a flowchart of a handover procedure based on UE mobility context, according to some implementations.

FIG. 4B illustrates a flowchart of another handover procedure based on UE mobility context, according to some implementations.

FIGS. 5A-5C illustrate example information elements (IEs) that a UE and a network entity exchange for communication connectivity management, according to some implementations.

FIG. 6 illustrates a flowchart of an example method, according to some implementations.

FIG. 7 illustrates a flowchart of another example method, according to some implementations.

FIG. 8 illustrates a UE, according to some implementations.

FIG. 9 illustrates an access node, according to some implementations.

### DETAILED DESCRIPTION

Mobility is a desired feature of modern wireless user devices. A user who moves from one location to another often carries a user device, sometimes referred to as UE, while performing tasks that require stable wireless service. These tasks include, e.g., conducting a phone call, attending a virtual conference, and watching a streamed video. Because different geographical areas are often served by different cells, the movement of the UE may result in degradation of signal strength that the UE receives from a cell currently serving the UE (“serving cell” or “source cell”). To maintain its connection with the network, the UE may need to make a connectivity change, such as initiating a handover to another cell (“target cell”) or switching to a frequency band with stronger signals.

In existing systems, the triggering of connectivity changes largely relies on the UE measuring the signal strength it receives from the source cell. The measurement, along with the subsequent connectivity change, takes time that may cause noticeable service interruption. The impact can be more severe when a sudden change of environment happens, such as when the UE moves into a tunnel at a high speed. In such a case, the extended time for handover or band switching may cause the service interrupt time longer than a preconfigured threshold, possibly leading to task failure and other undesirable consequences. Moreover, there are occasions that the UE does not actually need the connectivity change despite the degradation of the signal strength. For example, a user who frequents a remote area for hiking may not need high quality cellular service during the hike. Devoid of such information, the measurement-based mechanism may cause the UE to continuously look for service that meets the signal strength threshold for a serving cell, which unnecessarily consumes power of the UE.

In light of these challenges, this disclosure provides an improved connectivity management mechanism. As described in detail below, one or more implementations of this disclosure enable a UE to determine an anticipated mobility event based on contextual information before the event occurs, thereby readying itself for the expected connectivity change. One or more implementations also enable the UE to inform the network (e.g., base stations that provide cellular coverage) of the anticipated mobility event such that the connectivity change is smooth and efficient. Due to one or more features described below, implementations of this disclosure advantageously improve the stability, mobility, and efficiency of wireless communication.

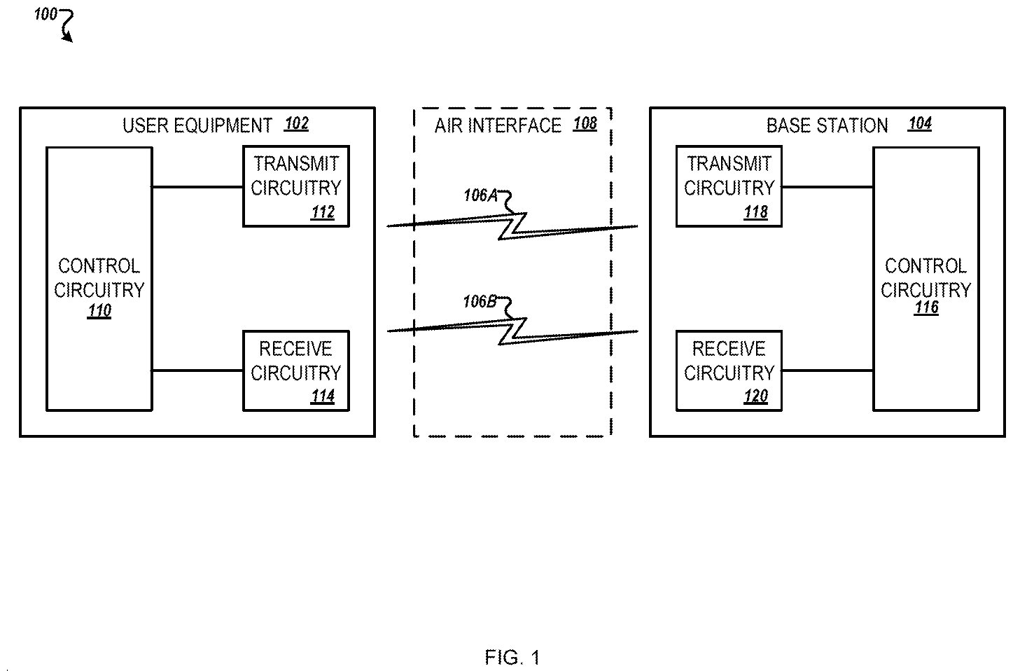

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can use contextual information to predict an upcoming mobility event and, when needed, control the transmit circuitry 112 and the receive circuitry 114 to make connectivity changes.

The transmit circuitry 112 can perform various operations described in this specification. For example, the transmit circuitry 112 can transmit messages to base station 104 to inform the base station 104 of its anticipated mobility event. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive configuration messages from the base station 104 to make connectivity changes. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

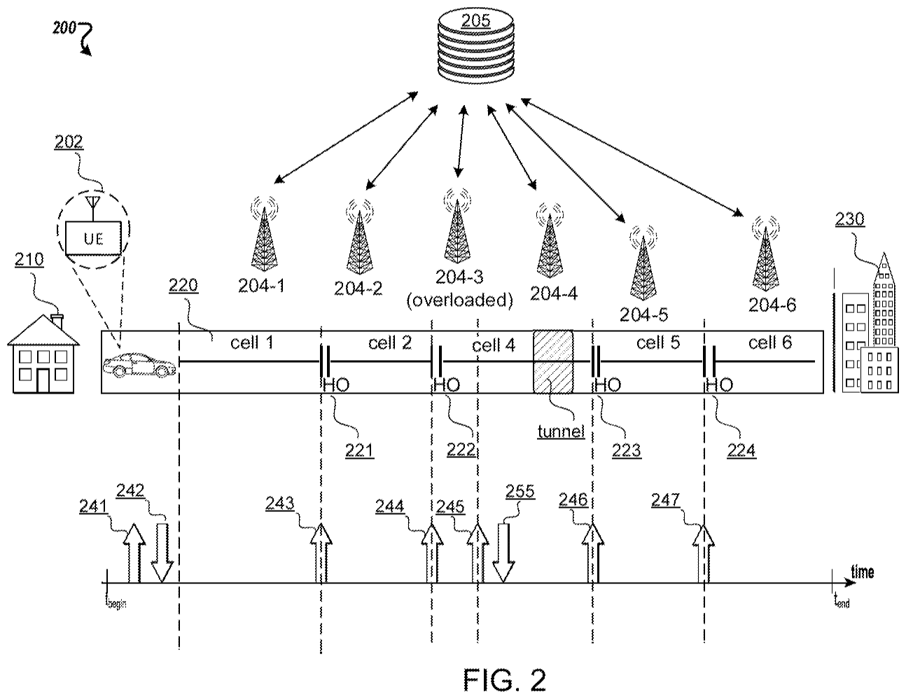

FIG. 2 illustrates an example scenario 200 of communication connectivity management based on UE mobility context, according to some implementations. In scenario 200, a user carrying UE 202 travels from house 210 to destination 230 in a vehicle along route 220. Route 220 is covered by six cells, cell 1 to cell 6. Each cell is managed by a base station, 204-1 to 204-6, collectively referred to as base stations 204. Base stations 204 are all associated with network entity 205. Network entity 205 provides network service to UE 202 via one or more of cells 1 to 6. Scenario 200 assumes cell 3 is overloaded and not suitable for delivering wireless service to UE 202. Moreover, scenario 200 assumes route 220 has a tunnel that causes degradation of wireless signal strength.

In scenario 200, UE 202 has a capability of connectivity management based on UE mobility context (“contextual mobility capability”). The UE mobility context can include information that describes connectivity activity during mobility of the UE. For example, UE 202 can obtain UE mobility context from the user's past or current interaction with UE 202, the mobility history of UE 202 (e.g., locations where UE 202 previously visited), information obtained from one or more sensors of UE 202, or contextual information obtained from other UEs. In some implementations, UE 202 can have on its own hardware or, alternatively, can be coupled to an analysis and crowdsourcing unit (ACU). The ACU, not shown in FIG. 2, can have one or more processors that store, process, anonymize, and analyze the data collected by many UEs. UE 202 can obtain some or all of the UE mobility context from the ACU. Additionally, UE 202 can transmit a message to inform network entity 205 of UE 202's contextual mobility capability. In response, network entity 205 can transmit a message to acknowledge (ACK) UE 202's contextual mobility capability and/or configure UE 202 to utilize such capability.

In scenario 200, when the user is about to depart from house 210, UE 202 predicts, based on the UE mobility context, that the user will carry UE 202 to destination 230 (e.g., the user's office) following route 220 in a time window from t_{begin} to t_{end}. UE 202 can make the prediction perhaps because the user has routinely travelled the same trip, the user has recorded the planned trip on UE 202, or other devices (e.g., a navigation system of the vehicle) inform UE 202 of the trip. Similarly, UE 202 can predict that the user will run applications on UE 202 that incur high data traffic between UE 202 and network entity 205. For example, UE 202 can predict that the user will use UE 202 to attend a virtual conference or watch live streaming videos based on the user's past or current behavior during the time window, the user's schedule recorded on UE 202, or information obtained from other devices.

With these predictions, UE 202 further predicts connectivity information that UE 202 will experience during route 220. The connectivity information can include an intensity of data traffic (e.g., high traffic or low traffic), a quality of service (QoS) (e.g., smooth connection or choppy connection), a cellular state (e.g., within coverage or out of coverage), and/or network context information (e.g., resource availability or cell quality). For example, UE 202 can predict that it will be located in geographical areas consecutively covered by cells 1-6 during the time window. Additionally, UE 202 can predict that its wireless connection will experience a slowdown or even interruptions when the vehicle travels in the tunnel.

Based on the predicted connectivity information, UE 202 can compile a list of anticipated mobility event(s). Each mobility event describes a change of connectivity information due to, e.g., a change of a radio environment of UE 202 or a change in data traffic of UE 202. Example mobility events include: transitioning between areas covered by different cells; entering or leaving an area, such as a building with thick walls, that causes signal strength degradation; starting or ending a task that incurs high data traffic; and switching to a low-power mode with reduced data speed.

In some implementations, UE 202 can compile the list of mobility events from the anticipated user behaviors without revealing the past, current, or anticipated user behaviors. For example, if UE 202 predicts a user on a phone call will enter a building with thick walls, UE 202 can describe the mobility event as a decrease of reference signal received power (RSRP) on the current frequency band of UE 202 for an extended period. As another example, if UE 202 predicts a user on a phone call will enter a tunnel for a short period, UE 202 can describe the mobility event as a brief decrease of RSRP on the current frequency band. As yet another example, if UE 202 predicts a user will begin a virtual conference using UE 202, UE 202 can describe the mobility event as a sharp increase in data traffic on the current frequency band. As a further example, if UE 202 predicts a user will begin a hiking activity that with minimal wireless communication activities, UE 202 can describe the mobility event as a decrease of data traffic on the current frequency band for an extended period. The first two examples of mobility events can be considered changes of radio environments, and the latter three can be considered changes in data traffic.

In some implementations, UE 202 transmits the list of anticipated mobility events to network entity 205. This is shown in FIG. 2 as message 241. As such, UE 202 provides advance notice to network entity 205 about upcoming connectivity information that UE 202 expects to experience. Along with the list, UE 202 can further include a request for network entity 205 to provide a load prediction of one or more of base stations 204.

In response, in message 242, network entity 205 configures UE 202 to make a connectivity change at one or more of the mobility events in the list. For example, network entity 205 can configure UE 202 to perform handover (HO) procedure 221 from cell 1 (associated with base station 204-1) to cell 2 (associated with base station 204-2) at a time when UE 202 is expected to transition from the coverage of cell 1 to the coverage of cell 2. Likewise, network entity 205 can configure UE 202 to perform similar handover procedures 222-224 when transitioning between cell coverages of the remaining cells. However, because cell 3 (associated with base station 204-3) is overloaded, network entity 205 can configure UE 202 to bypass cell 3 and perform handover 222 between cell 2 and cell 4. This configuration not only saves the power of UE 202 from unnecessary handover attempt with cell 3, but also allows UE 202 to prepare for the handover early to improve connection quality at the handover.

In addition to the connectivity change configuration, network entity 205 can include in the message 242 the load prediction of one or more of cells 1-6. This can help UE 202 make more informed connectivity change decisions. For example, in a similar scenario to 200, even if none of the cells are currently overloaded, the network entity can configure the UE to skip handover to a low-capacity cell if the network entity anticipates that the low-capacity cell will be overloaded at a later time (e.g., because the user will later perform a task that incurs significant data traffic, which thereby will overload the low-capacity cell).

Besides handover configurations, network entity 205 can configure a plurality of parameters for UE 202 to make the connectivity change. The parameters can include UE-dedicated parameters for a particular base station, such as configurations of a frequency band of UE 202, an antenna of UE 202, or a beam of UE 202. Additionally and/or alternatively, the parameters can include timers at one or more layers, such as radio link control (RLC) or packet data convergence protocol (PDCP). Additionally and/or alternatively, the parameters can include one or more dedicated random access channel (RACH) preambles that prepared and released by network entity 205. The parameters can also include a scheme for link adaptation for fast resumption of grant and resource allocation (e.g., fast resumption of a modulation coding scheme [MCS] based on a channel quality indicator [CQI]). The parameters can further include a maximum number of retransmissions, configured at the medium access control (MAC) layer or at the RLC layer, to accommodate signal quality changes. By accessing and using these parameters when the mobility event occurs, UE 202 can adapt to the environmental or data traffic changes with suitable resources and configurations, thereby reducing connection interruption and power consumption.

As the vehicle travels along route 220, UE 202 can continue to make predictions of mobility events and occasionally or regularly transmit update messages 243-247 to network entity 205. Update messages 243-247 can include the updated connectivity information of UE 202. For example, UE 202 can update network entity 205 that handover 221 is on track to being performed. In addition, UE 202 can update network entity 205 of a deviation between the anticipated mobility events and the actual mobility events. For example, assuming that UE 202 did not foresee the signal degradation due to the tunnel until the middle of the trip, UE 202 can update, via update message 245, network entity 205 with a new mobility event describing the newly-predicted signal degradation. In turn, in message 255, network entity 205 can configure UE 202 in anticipation of the new mobility event. For example, network entity 205 can configure UE 202 to delay the initially-scheduled HO 223 until the vehicle completely exits the tunnel. As another example, network entity 205 can configure UE 202 to increase a radio link failure timer while in the tunnel so that UE 202 has more time to reestablish a lost network connection.

UE 202 and network entity 205 can respectively make mobility event predictions and cell load predictions using artificial intelligence (AI) or machine learning. For example, UE 202 can input UE mobility context to a machine learning engine, either implemented on UE 202 or accessible to UE 202 via a network. The machine learning engine calculates a probability that a user behavior will happen during a period of time. If the probability is higher than a predetermined confidence threshold, then the machine learning engine makes a positive prediction of the user behavior and the corresponding mobility event. UE 202 and network entity 205 can determine the method of calculating the probability and/or the confidence threshold prior to the predictions.

As an example of using the machine learning engine, the user in scenario 200 opens a navigation application on UE 202 and plans a trip from house 210 to destination 230. UE 202 inputs this information, along with other contextual information describing the travel routes of this user and other users, to a machine learning engine. The machine learning engine then predicts the probabilities of UE 202 being connected to cells 1-6 at various stages of the trip. For example, the machine learning engine can predict that the probability of UE 202 being connected to cell 1 at t_{begin} is 100% while the probabilities of being connected to other cells are all 0. The machine learning engine also predicts that the probabilities of UE 202 being connected to cell 1-6 five minutes after t_{begin} are 10%, 20%, 40%, 15%, 10%, and 5%, respectively. UE 202 obtains these predictions, and other predictions similarly made by the machine learning engine, and compiles a list of the mobility event.

Network entity 205 can make cell load predictions similarly based on, e.g., history cell load data and mobility events predicted by many UEs. Network entity 205 can further share the cell load predictions and other network connectivity information to base stations within the network. This can enhance the network's capability of performing handover procedures, load balancing, and power management.

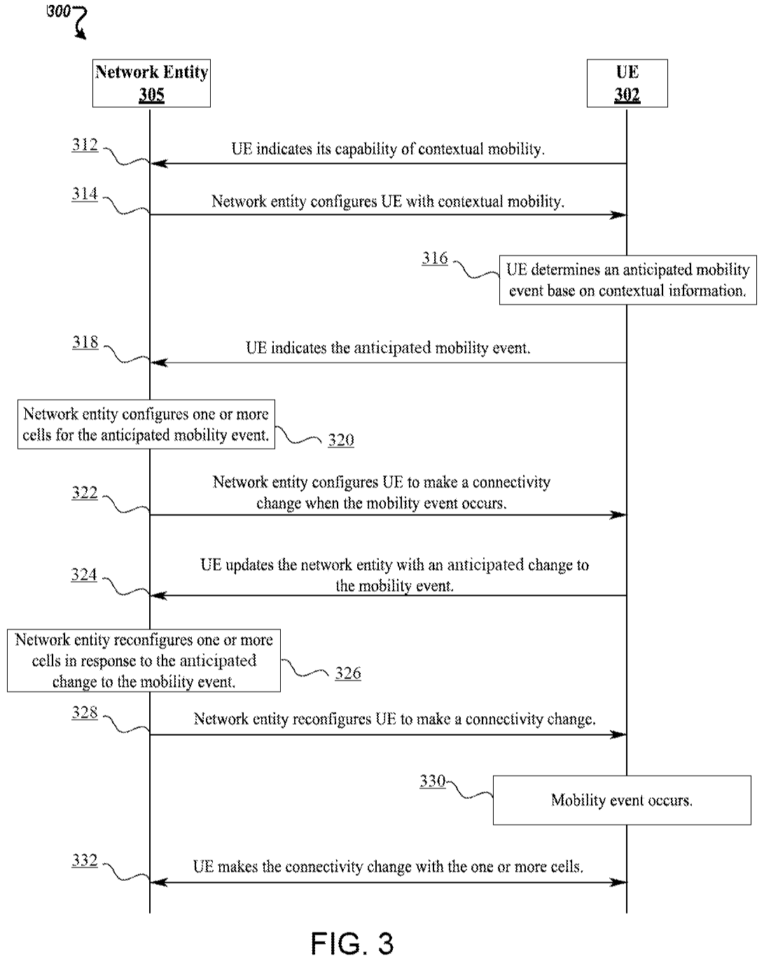

FIG. 3 illustrates a flowchart of example interactions 300 between UE 302 and network entity 305, according to some implementations. UE 302 and network entity 305 can be similar to UE 202 and network entity 205, respectively, of FIG. 2. Also, some interactions illustrated in FIG. 3 can be similar to the operations described with reference to FIG. 2.

At 312, UE 302 indicates its contextual mobility capability to network entity 305. To do so, UE 302 can transmit an IE, such as contextualCapability. Within contextualCapability, UE 302 can indicate its capability of contextual mobility. UE 302 can also indicate the contextual mobility features it supports, such as types of events, prediction method, confidence level, and privacy level.

At 314, network entity 305 configures UE 302 with contextual mobility. The configuration can include an ACK to UE 302's indicated contextual mobility capability. The configuration can also include parameters for UE 302 to make context-based mobility event predictions. For example, the configuration can include a MeasurementConfig IE. The MeasurementConfig IE can configure UE 302 to report mobility event predictions (e.g., in message 241 of FIG. 2) as part of a radio resource control (RRC) measurement report. Alternatively or additionally, the MeasurementConfig IE can configure UE 302 to report prediction updates (e.g., in messages 243-247 of FIG. 2).

At 316, UE 302 determines an anticipated mobility event base on contextual information. Similar to the description of FIG. 2, UE 302 can determine the anticipated mobility event using an AI or machine learning engine from probabilities of the mobility event.

At 318, UE provides an indication of the anticipated mobility event to network entity 305. The prediction can be included as part of a measurement report (e.g., in message 241 of FIG. 2). In some implementations, the indication includes a MeasurementReport IE. Apart from the anticipated mobility event, the MeasurementReport IE can include a request for network entity 305 to provide a dedicated configuration for one or more cells and/or a request for load predictions of one or more cells.

At 320, network entity 305 configures one or more cells in anticipation of a connectivity change from the mobility event. For example, network entity 305 can inform the involved base stations to allocate resources for a handover. As another example, network entity 305 can configure the involved base stations to give UE 302 higher priority of service than UEs not enabling contextual mobility capability.

At 322, network entity 305 configures UE 302 to make a connectivity change, such as a handover, when the mobility event occurs. The configuration can be included in a message (e.g., message 242 of FIG. 2) and can be part of an RRC reconfiguration procedure. Along with the configuration, network entity 305 can share load predictions of one or more cells with UE 302.

At 324, UE 302 updates network entity 305 with a anticipated change to the mobility event. The update can be included in a message (e.g., messages 243-247 of FIG. 2) that UE 302 transmits occasionally or regularly. In some implementations, the update message includes a MeasurementReport IE. Within the MeasurementReport IE, UE 302 can include a release indication of one or more cells that UE 302 decides to not connect to (e.g., cell 3 of FIG. 2).

At 326, network entity 305 reconfigures one or more cells in response to the anticipated change to the mobility event. For example, network entity 305 can instruct a cell to prepare for a handover at an updated time or release a cell from a planned handover.

At 328, network entity 305 reconfigures UE 302 to make a connectivity change. The reconfiguration can be based on, e.g., updated predictions of the mobility event and/or cell loads.

At 330, the mobility event occurs. At 332, upon detecting the occurrence of the mobility event, UE 302 makes the connectivity change with the one or more cells as planned. For example, UE 302 can start the measurement for a handover procedure between two cells. Because UE 302 and network entity 305 both have planned ahead of the mobility event, UE 302 can make the connectivity change smoothly and efficiently.

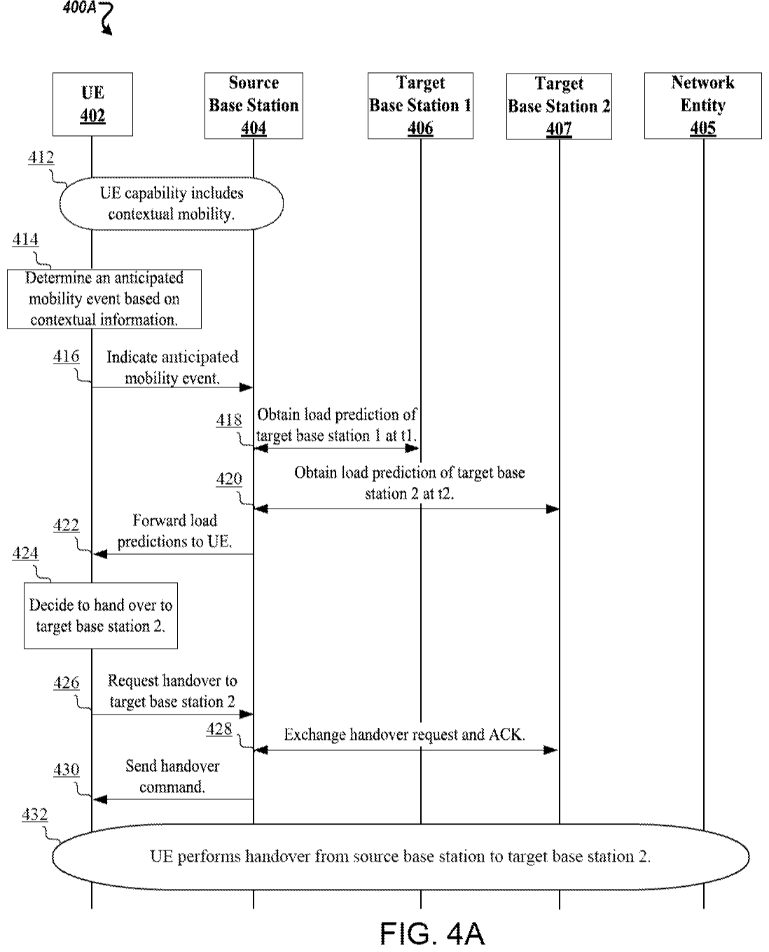

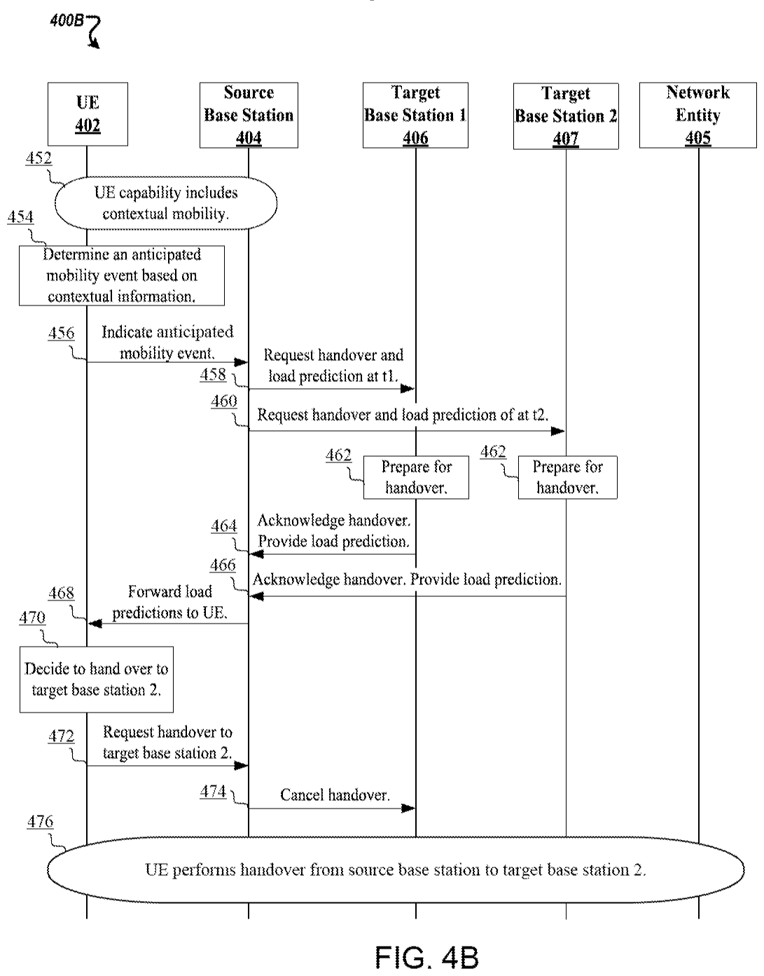

As previously mentioned, handover is a connectivity change that a UE often makes at certain types of mobility events. The handover process transfers a UE connection from a source cell to a target cell while maintaining connection continuity. Multiple types of handover are available for UEs that have the contextual mobility capability. Two example handover procedures 400A and 400B are described below with reference to FIGS. 4A and 4B. In both procedures 400A and 400B, UE 402 is connected to a network controlled by network entity 405. Network entity 405 controls three base stations 404, 406, and 407. Base station 404 serves as the source base station that manages the source cell. Base stations 406 and 407 serve as target base stations that manage cells that are candidates of the handover target. UE 402 and network entity 405 can be similar to UE 202 and network entity 205, respectively, or UE 302 and network entity 305, respectively. Base stations 404, 406, and 407 can be similar to base stations 204 of FIG. 2.

FIG. 4A illustrates a flowchart of a handover procedure 400A based on UE mobility context, according to some implementations. Procedure 400A illustrates a type of handover often referred to as “baseline handover.” In baseline handover, the target base station sends a handover request with only one target base station.

At 412, UE 402 communicates with network entity 405 via source base station 404 to indicate and configure the contextual mobility capability of UE 402. At 414, UE 402 determines an anticipated mobility event based on contextual information. At 416, UE 402 provides an indication of the anticipated mobility event to network entity 405 via source base station 404. These operations can be similar to 312-318 of FIG. 3.

At 418, source base station 404 obtains a load prediction of target base station 406 at t1. Here, t1 can be an estimated time when UE 402 is available for handover to target base station 406. For example, source base station 404 can send a request to target base station 406 while providing t1. In response, target base station 406 can make the prediction based on, e.g., its current load level and/or history load level. Target base station 406 can then send the load prediction back to source base station 404.

Similar to 418, at 420, source base station 404 obtains a load prediction of target base station 407 at t2. Here, t2 can be an estimated time when UE 402 is available for handover to target base station 407.

At 422, source base station 404 forwards the load predictions from target base stations 406 and 407 to UE 402. Operation at 422 can be similar to 322 of FIG. 3.

At 424, UE 402 decides to be handed over to target base station 407. UE 402 can make this decision based on various factors, such as the load predictions of the two target base stations, UE 402's contextual information, or UE's history connection data with the two target base stations.

At 426, UE 402 informs source base station 404 of the handover decision by sending a handover request to source base station 404.

At 428, source base station 404 sends a handover request to target base station 407, and target base station 407 sends a handover ACK to source base station 404. Because target base station 406 does not receive a handover request, target base station 406 does not prepare for a handover with UE 402.

At 430, source base station 404 sends a handover command to UE 402. The handover command can serve as a confirmation of UE 402's handover request, and/or can serve as a trigger of the handover process.

At 432, UE 402, source base station 404, and target base station 407 perform the handover procedure as requested by UE 402. The handover procedure can involve exchange of a variety of signals depending on the communications protocol. Upon completion, target base station 407 becomes the new serving base station for UE 402 to continue receiving network service provided by network entity 405.

FIG. 4B illustrates a flowchart of a handover procedure 400B based on UE mobility context, according to some implementations. Procedure 400B illustrates a type of handover often referred to as “conditional handover.” In conditional handover, the target base station requests handover with more than one candidate target base stations but the actual performance of handover is contingent upon certain conditions are satisfied.

Operations at 452-456 of FIG. 4B are similar to operations at 412-416 of FIG. 4A. These operations can also be similar to 312-318 of FIG. 3.

At 458, source base station 404 sends a handover request to target base station 406. Along with the handover request, source base station 404 requests target base station 406 to provide a load prediction at t1.

Similar to 458, at 460, source base station 404 sends a handover request to target base station 407. Along with the handover request, source base station 404 requests target base station 407 to provide a load prediction at t1.

At 462, target base stations 406 and 407 each prepares for the handover as requested by source base station 404.

At 464, target base station 406 sends a handover ACK message to source base station 404. Along with the ACK message, target base stations 406 provides source base station 404 with the requested load prediction.

Similar to 464, at 466, target base station 407 sends a handover ACK message to source base station 404. Along with the ACK message, target base stations 407 provides source base station 404 with the requested load prediction.

At 468, source base station 404 forwards the load predictions from target base stations 406 and 407 to UE 402. Operation at 468 can be similar to 322 of FIG. 3 or 422 of FIG. 4A.

At 470, UE 402 decides to be handed over to target base station 407. The decision involves determining that one or more conditions are satisfied. For example, network entity 405 can configure UE 402, via the message transmitted at 468, to perform handover with a target base station if the target base station's predicted load is below a certain level at a certain time. Assuming the one or more conditions are satisfied for target base station 407 but not for target base station 406, UE 402 decides to be handed over to target base station 407.

At 472, UE 402 informs source base station 404 of the handover decision by sending a handover request to source base station 404. In the handover request, UE 402 can explicitly or implicitly request cancellation of the handover with target base station 406.

At 474, source base station 404 cancels the handover with target base station 406.

At 476, UE 402, source base station 404, and target base station 407 perform the handover procedure as requested by UE 402. The operation at 476 can be similar to 432 of FIG. 4A.

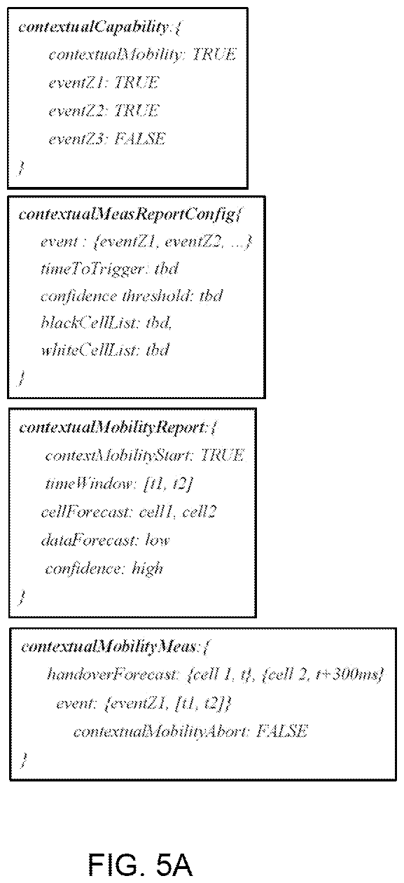

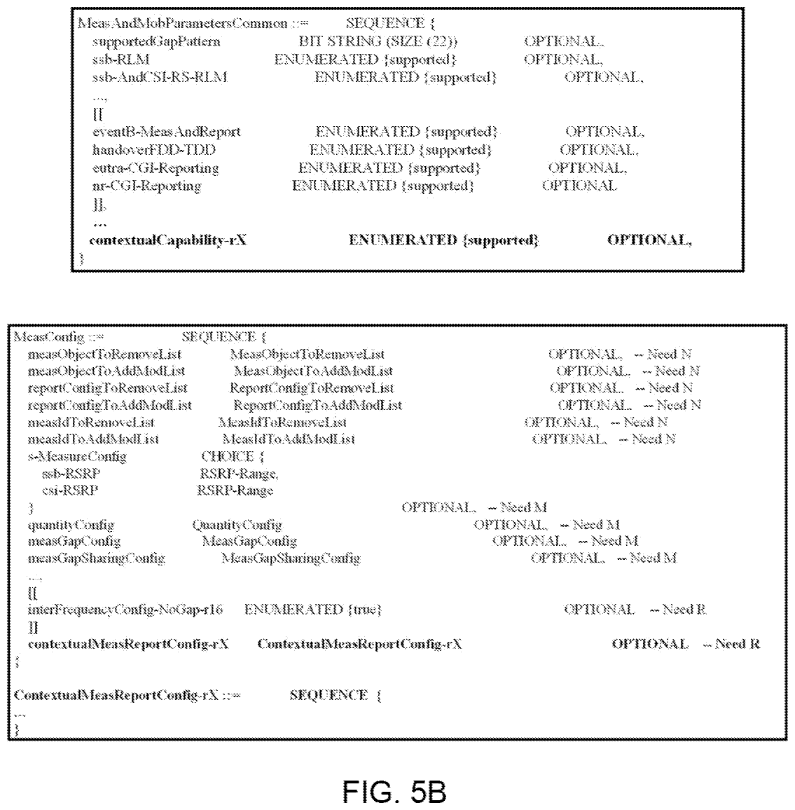

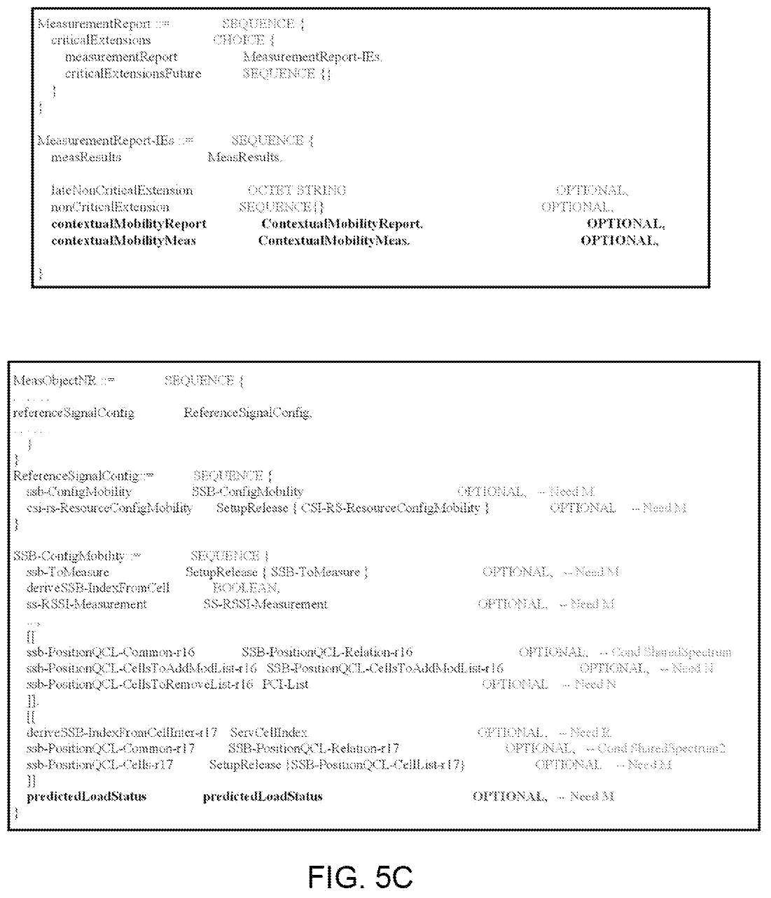

FIGS. 5A-5C illustrate example IEs that a UE and a network entity exchange for communication connectivity management based on mobility context, according to some implementations.

FIG. 5A illustrates four IEs: contextualCapability, contextualMeasReportConfig, contextualMobilityReport, and contextualMobilityMeas. A UE and a network entity can use these IEs for connectivity changes, such as handover.

As discussed earlier, a UE can use contextualCapability to indicate its contextual mobility capability. For example, the UE can set the contextualMobility field to be TRUE and set the various event fields (eventZ1, eventZ2, . . . ) according to the types of supported mobility events.

A network entity can use contextualMeasReportConfig to configure the UE to perform measurements. For example, the network entity can use the event field to specify which events will trigger the measurement, and use the timeToTrigger field to specify the timing for triggering the measurements. Alternatively or additionally, the network entity can use the confidence threshold field, the blackCellList field, and the whileCellList field to configure a confidence threshold value used in the measurements and blacklist or whitelist any cells for the measurements.

The UE can use contextualMobilityReport to provide the network entity with the anticipated mobility events and the time window. For example, the UE can use the contextMobilityStart to indicate that its contextual mobility capability is enabled. The UE can use the timeWindow field to indicate the beginning and the end of the time window when the mobility events are expected to occur. The UE can use the cellForecast, dataForecast, and confidence fields to describe a anticipated mobility event and the level of confidence.

The UE can use contextualMobilityMeas to provide the network entity with updated information about the anticipated mobility events. For example, the UE can the handoverForecast field to indicate an updated handover request. The UE can use the event field to indicate an updated prediction of a mobility event. The UE can further use the contextualMobilityAbort field to indicate whether the UE has aborted its contextual mobility capability.

For UEs that comply with 5G or implement similar communications protocols, the four IEs of FIG. 5A can be instantiated as parameters within existing IEs provided by 5G. For example, as illustrated in FIG. 5B, the contextualCapability IE can be instantiated as contextualCapability-rx under the MeasAndMobParametersCommon IE. Additionally, the contextualMeasReportConfig IE can be instantiated as contextualMeasReportConfig-rx under the MeasConfig IE. Similarly, as illustrated in FIG. 5C, the contextualCapability IE can be instantiated as contextualCapability-rx under the MeasAndMobParametersCommon IE. Additionally, the contextualMobilityReport and contextualMobilityMeas IEs can both be instantiated under the MeasurementReport-IEs IE.

In addition to the four elements illustrated in FIG. 5A, existing 5G-compliant IEs can include other parameters related to a UE's contextual mobility capability. For example, as illustrated in FIG. 5C, the MeasObjectNR IE can instantiate, through one or more layers of hierarchy, a predictedLoadStatus IE. The network entity can use the predictedLoadStatus IE to indicate the load prediction of one or more cells.

FIGS. 5A-5C illustrate only a few out of numerous possible structures that a UE and a network entity can implement for communication connectivity management based on mobility context. These implementations, 5G-compliant or not, offer network users and providers great flexibility to support a UE with contextual mobility capability.

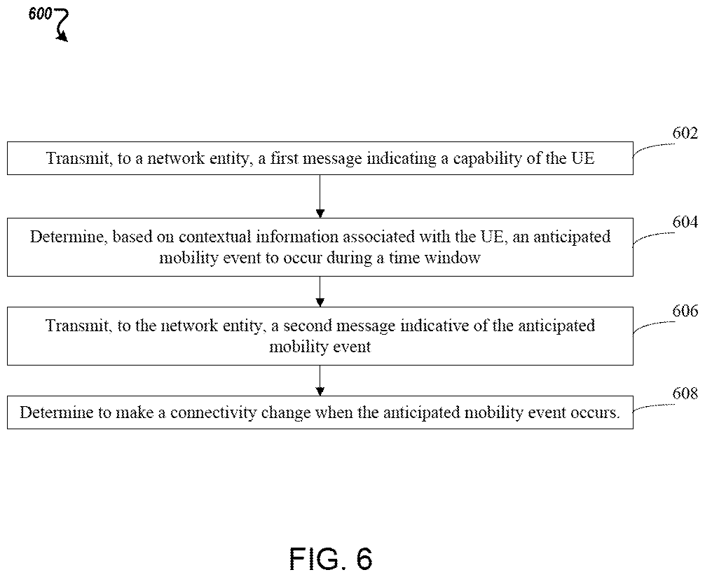

FIG. 6 illustrates a flowchart of an example method 600, according to some implementations. For clarity of presentation, the description that follows generally describes method 600 in the context of the other figures in this description. For example, method 600 can be performed by UEs 102, 202, 302, or 402. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

At 602, method 600 involves transmitting a first message to a network entity, such as network entities 305 or 405. The first message indicates a capability of a UE, such as contextual mobility capability. The transmission of the first message can be similar to operation at 312 of FIG. 3.

At 604, method 600 involves determining, based on contextual information associated with the UE, an anticipated mobility event to occur during a time window. The determination can be similar to the operations at 316, 414, or 454. The mobility event can include one or more of those described in example scenario 200.

At 606, method 600 involves transmitting a second message to the network entity. The second message indicates the mobility event to the network entity. The second message can be similar to message 241 in example scenario 200. The transmission of the second message can be similar to operations at 318 of FIG. 3, 416 of FIG. 4A, or 456 of FIG. 4B.

At 608, method 600 involves determining to make a connectivity change when the mobility event occurs. The determination can be based on a configuration message, such as message 242 in example scenario 200. If the connectivity change involves a handover, the determination can be similar to 424 or 470 in FIGS. 4A and 4B.

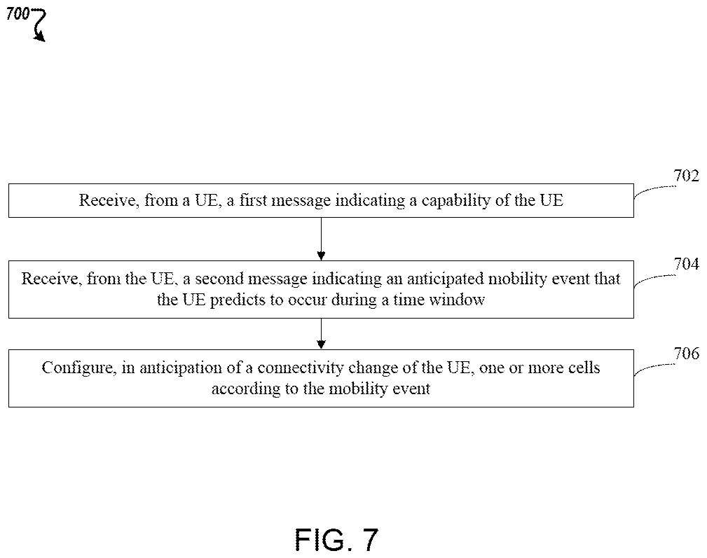

FIG. 7 illustrates a flowchart of an example method 700, according to some implementations. For clarity of presentation, the description that follows generally describes method 700 in the context of the other figures in this description. For example, method 700 can be performed by network entities 305 or 405 of FIGS. 3-4B. It will be understood that method 700 can be performed, for example, by any suitable system, environment, software, hardware, or a combination of systems, environments, software, and hardware, as appropriate. In some implementations, various steps of method 700 can be run in parallel, in combination, in loops, or in any order.

At 702, method 700 involves receiving a first message from a UE, such as network entities 305 or 405. The first message indicates a capability of a UE, such as contextual mobility capability. The reception of the first message can be similar to operation at 312 of FIG. 3.

At 704, method 700 involves receiving a second message from the UE. The second message indicates an anticipated mobility event that the UE predicts to occur during a time window. The second message can be similar to message 241 in example scenario 200. The reception of the second message can be similar to operations at 318 of FIG. 3, 416 of FIG. 4A, or 456 of FIG. 4B.

At 706, method 700 involves configuring one or more cells according to the mobility event in anticipation of a connectivity change. The configuration can include, e.g. requesting the cell to provide load predictions or instructing a cell to prepare for a handover.

The features of the implementations allow a UE to consider contextual information when planning for connectivity changes in anticipation of mobility events. With these features, the UE and the network entity become more informed and efficient when making connectivity changes. These features can be implemented without fundamental changes to existing communications protocol and, therefore, offer great flexibility and scalability.

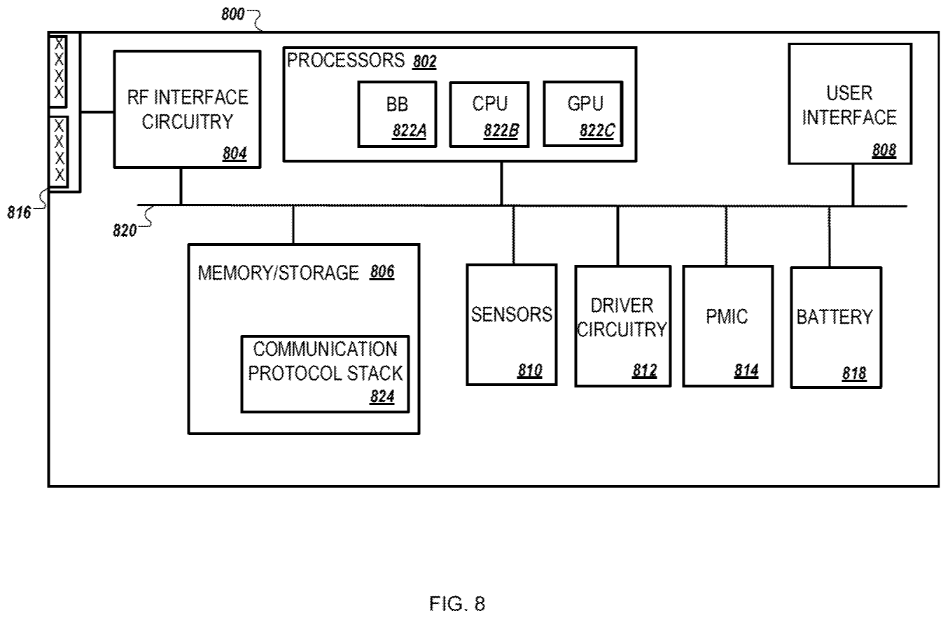

FIG. 8 illustrates a UE 800, according to some implementations. The UE 800 may be similar to and substantially interchangeable with UE 102 of FIG. 1.

The UE 800 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, one or more antenna(s) 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some implementations, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 804. The baseband processor circuitry 822A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some implementations, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 816. In various implementations, the RF interface circuitry 804 may be configured to transmit/receive signals in a manner compatible with NR access technologies.

The antenna(s) 816 may include one or more antenna elements to convert electrical signals into radio waves to travel through the air and to convert received radio waves into electrical signals. The antenna elements may be arranged into one or more antenna panels. The antenna(s) 816 may have antenna panels that are omnidirectional, directional, or a combination thereof to enable beamforming and multiple input, multiple output communications. The antenna(s) 816 may include microstrip antennas, printed antennas fabricated on the surface of one or more printed circuit boards, patch antennas, phased array antennas, etc. The antenna(s) 816 may have one or more panels designed for specific frequency bands including bands in FR1 or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensors 810 and control and allow access to sensors 810, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some implementations, the PMIC 814 may control, or otherwise be part of, various power saving mechanisms of the UE 800. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

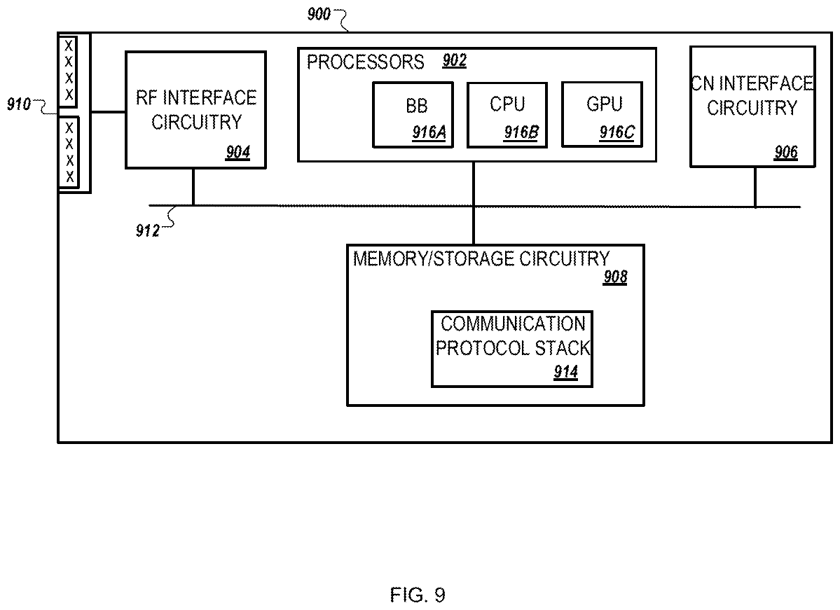

FIG. 9 illustrates an example access node 900 (e.g., a base station or gNB), according to some implementations. The access node 900 may be similar to and substantially interchangeable with base station 104. The access node 900 may include processors 902, RF interface circuitry 904, core network (CN) interface circuitry 906, memory/storage circuitry 908, and one or more antenna(s) 910.

The components of the access node 900 may be coupled with various other components over one or more interconnects 912. The processors 902, RF interface circuitry 904, memory/storage circuitry 908 (including communication protocol stack 914), antenna(s) 910, and interconnects 912 may be similar to like-named elements shown and described with respect to FIG. 8. For example, the processors 902 may include processor circuitry such as, for example, baseband processor circuitry (BB) 916A, central processor unit circuitry (CPU) 916B, and graphics processor unit circuitry (GPU) 916C.

The CN interface circuitry 906 may provide connectivity to a core network, for example, a 5th Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 906 may include one or more dedicated processors or FPGAs to communicate using one or more of the aforementioned protocols. In some implementations, the CN interface circuitry 906 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 900 that operates in an NR or 5G system (for example, a gNB), and the term “E-UTRAN node” or the like may refer to an access node 900 that operates in an LTE or 4G system (e.g., an eNB). According to various implementations, the access node 900 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 900 may be implemented as one or more software entities running on server computers as part of a virtual network, which may be referred to as a CRAN and/or a virtual baseband unit pool (vBBUP). In V2X scenarios, the access node 900 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. One or more processors comprising circuitry that executes instructions to cause a user equipment (UE) to perform operations comprising:
transmitting, to a network entity, a first message indicating a capability of the UE;
determining, based on contextual information associated with the UE, an anticipated mobility event to occur during a time window;
transmitting, to the network entity, a second message indicative of the mobility event; and
determining to make a connectivity change when the mobility event occurs.

2. The one or more processors of claim 1, the operations further comprising:
determining that the mobility event occurs during the time window; and
making the connectivity change when the mobility event occurs.

3. The one or more processors of claim 1, wherein determining to make the connectivity change when the mobility event occurs comprises:
receiving, from the network entity, a third message configuring the UE to make the connectivity change when the mobility event occurs.

4. The one or more processors of claim 1, the operations further comprising:
determining, based on an update of the contextual information, an anticipated change to the mobility event; and
transmitting, to the network entity, a fourth message indicative of the change to the mobility event.

5. The one or more processors of claim 1, wherein the connectivity change comprises at least one of: (i) a handover of the UE from a source base station to a target base station, or (ii) changing an operating frequency band of the UE.

6. The one or more processors of claim 3,
wherein the third message further indicates a load prediction on one or more base stations associated with the network entity.

7. The one or more processors of claim 1, wherein the contextual information comprises at least one of:
a user's interaction with the UE,
a mobility history of the UE,
information obtained from one or more sensors of the UE, or
contextual information obtained from other UEs.

8. The one or more processors of claim 1, wherein determining the anticipated mobility event based on the contextual information comprises:
determining, based on the contextual information, an anticipated user behavior that causes the UE to change location during the time window; and
determining a correlation between the location change and the mobility event.

9. The one or more processors of claim 1, wherein the mobility event comprises at least one of:
a change of a radio environment of the UE, or
a change of a data traffic of the UE.

10. The one or more processors of claim 1, the operations further comprising: receiving, from the network entity, one or more information elements that indicate a type of the mobility events supported by the UE.

11. The one or more processors of claim 3,
wherein the third message comprises one or more parameters for the UE to make the connectivity change,
wherein the UE accesses the one or more parameters upon occurrence of the mobility event, and
wherein the one or more parameters configure at least one of:
a frequency band,
an antenna,
a beam,
a timer that measures a radio link failure,
a random access channel (RACH) preamble,
a scheme for link adaptation, or
a maximum number of retransmissions.

12. The one or more processors of claim 8, wherein determining the anticipated user behavior based on the contextual information comprises:
inputting the contextual information to a machine learning engine;
calculating, using the machine learning engine, a probability that the user behavior will occur during the time window; and
comparing the probability with a predetermined confidence threshold.

13. A network entity, comprising one or more processors configured to execute instructions that cause the network entity to perform operations comprising:
receiving, from a user equipment (UE), a first message indicating a capability of the UE;
receiving, from the UE, a second message indicating an anticipated mobility event that the UE predicts to occur during a time window; and
configuring, in anticipation of a connectivity change of the UE, one or more base stations according to the anticipated mobility event.

14. The network entity of claim 13, the operations further comprising:
transmitting a third message to the UE, the third message configuring the UE to make the connectivity change when the mobility event occurs.

15. The network entity of claim 14, the operations further comprising:
making a load prediction for the one or more base stations based on the second message,
wherein the third message further indicates the load prediction.

16. The network entity of claim 14,
wherein the third message comprises one or more parameters for the UE to make the connectivity change, and
wherein the one or more parameters configure at least one of:
a frequency band,
an antenna,
a beam,
a timer that measures a radio link failure,
a random access channel (RACH) preamble,
a scheme for link adaptation, or
a maximum number of retransmissions.

17. The network entity of claim 13, the operations further comprising:
receiving a fourth message from the UE, the fourth message indicating an anticipated change to the mobility event; and
reconfiguring the one or more base stations according to the anticipated change to the mobility event.

18. The network entity of claim 13, wherein the connectivity change comprises a handover of the UE from a source base station to a target base station of the one or more base stations.

19. The network entity of claim 13, wherein the connectivity change comprises changing an operating frequency band of the UE.

20. A method, comprising:
transmitting, to a network entity, a first message indicating a capability of a user equipment (UE);
determining, based on contextual information associated with the UE, an anticipated mobility event to occur during a time window;
transmitting, to the network entity, a second message indicative of the mobility event; and
determining to make a connectivity change when the mobility event occurs.
